(19) United States
(12) Patent Application Publication
(10) Pub. No.: US 2010/0049931 A1
(43) Pub. Date: Feb. 25, 2010

(54) Copying Logical Disk Mappings Between Arrays

(76) Inventors: Michael B. Jacobson, Boise, ID (US); Susan L. Larson, Meridian, ID (US); Brian Patterson, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,920

(22) Filed: Oct. 1, 2008

Related U.S. Application Data
(60) Provisional application No. 61/090,246, filed on Aug. 20, 2008.

(51) Int. Cl. G06F 12/16; G06F 12/00; G06F 11/14; G06F 12/02

(52) U.S. Cl. 711/162; 711/112; 711/202; 707/206; 714/5; 711/E12.001; 711/E12.103; 707/E17.044; 714/E11.113

(57) ABSTRACT

In one embodiment, a storage controller comprises a first port that provides an interface to a host computer, a second port that provides an interface to a storage device, a processor, and a memory module communicatively connected to the processor and comprising logic instructions stored on a computer readable storage medium which, when executed by the processor, configure the processor to copy a logical disk mapping from a first storage array managed by a source storage controller to a second storage array managed by a destination storage controller by performing operations comprising obtaining, in the source storage controller, an object identifier listing for use with the logical disk mappings in the destination storage controller, copying, in the source storage controller, contents of logical disk mappings for use in the first storage array from a first storage container to a second storage container, and replacing, in the source storage controller, object identifiers associated with the logical disk mappings in the first storage array with object identifiers from the object identifier listing received in the first storage controller.

### RELATED APPLICATIONS

This application claims the benefit of priority of U.S. Provisional Patent Application Ser. No. 61/090,246, filed Aug. 20, 2008, entitled COPYING LOGICAL DISK MAPPINGS BETWEEN ARRAYS, the disclosure of which is incorporated herein in its entirety.

### BACKGROUND

Enterprises commonly maintain multiple copies of important data and expend large amounts of time and money to protect this data against losses due to disasters or catastrophes. In some storage systems, data is stored across numerous disks that are grouped together. These groups can be linked with arrays to form clusters having a large number of individual disks.

In cluster storage systems, data availability can be disrupted while arrays or groups of disks are being managed. For instance, it may be desirable to transfer access to disk groups from one array to another array. During this transfer, however, applications accessing data within the disk group can fail or timeout and cause a disruption to application service and operation of the enterprise. Such disruptions can also occur when arrays are added or removed from a cluster.

Regardless of the backup or data transfer techniques being used, enterprises can lose valuable time and money when storage arrays are taken offline or shutdown. In these situations, applications are shutdown, storage devices are disconnected and reconnected, LUNs (logical unit numbers) are re-mapped, etc. While the storage arrays are offline, operation of the enterprise is disrupted and jeopardized.

### BRIEF DESCRIPTION OF THE DRAWINGS

Various disclosed embodiments will be better understood from a reading of the following detailed description, taken in conjunction with the accompanying Figures in the drawings in which:

FIG. 1 is a schematic illustration of an exemplary implementation of a networked computing system that utilizes a storage network, according to an embodiment.

FIG. 2 is a schematic illustration of an exemplary implementation of a storage network, according to an embodiment.

FIG. 3 is a schematic illustration of an exemplary implementation of a computing device that can be utilized to implement a host, according to an embodiment.

FIG. 4 is a schematic illustration of an exemplary implementation of a storage cell, according to an embodiment.

FIG. 5 illustrates an exemplary memory representation of a LUN, according to an embodiment.

FIG. 6 is a schematic illustration of data allocation in a virtualized storage system, according to an embodiment.

FIG. 7 is a flowchart illustrating operations in a method to copy logical disk mappings between storage arrays, according to an embodiment.

### DETAILED DESCRIPTION

Described herein are exemplary system and methods to copy logical disk mappings between storage array controllers. In some embodiments, various methods described herein may be embodied as logic instructions on a computer-readable medium, e.g., as firmware in a storage array controller. When executed on a processor, the logic instructions cause the processor to be programmed as a special-purpose machine that implements the described methods. The processor, when configured by the logic instructions to execute the methods recited herein, constitutes structure for performing the described methods. Thus, in embodiments in which the logic instructions are implemented on a processor on an array controller, the methods implemented herein may be implemented as a component of a storage array controller. In alternate embodiments, the methods described herein may be embodied as a computer program product stored on a computer readable storage medium which may be distributed as a stand-alone product.

In some embodiments, the methods described herein may be implemented in the context of a clustered array storage architecture system. As used herein, a clustered array storage architecture refers to a data storage system architecture in which multiple array storage systems are configured from a pool of shared resources accessible via a communication network. The shared resources may include physical disks, disk shelves, and network infrastructure components. Each array storage system, sometimes referred to as an “array” comprises at least one (and typically a redundant pair) of storage array controllers which manages a subset of the shared resources.

As used herein, the phrase “disk group” refers to an object which comprises a set of physical disks and one or more logical disks which constitute the storage containers visible to components and users of the storage system. Logical disks are virtual objects that use the physical disks as a backing store for host data. A mapping scheme, typically implemented and managed by the storage array controller, defines the relationship between the logical storage container and the underlying physical storage.

In some embodiments, storage systems permit access to a disk group to be transferred from a first array to a second array. In this context, the first array is commonly referred to as a “source” array and the second array is commonly referred to as a “destination” array. As used herein, the term “transfer” refers to the process of moving access of a disk group from a source array to a destination array.

During a transfer process the underlying data associated with the disk group being transferred need not be moved. Rather, access to and control over the data is moved from the source controller to the destination controller. Thus, various metadata and mapping structures used by the source array controller to manages access to the disk group needs to be copied from the source controller to the destination controller, so that the destination array controller can manage access to the disk group. In some storage systems, the identities of objects used by the destination controller in the logical mapping structures may differ from the identities of objects used by the source controller. Thus, in some embodiments, the methods described herein enable the object identities to be changed during the copy process. In addition, a method is provided to permit quick recovery in the event of a failure during the transfer process.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

The subject matter described herein may be implemented in a storage architecture that provides virtualized data storage at a system level, such that virtualization is implemented within a SAN. In implementations described herein, the computing systems that utilize storage are referred to as hosts. As used herein, the term “host” refers to any computing system that consumes data storage resources capacity on its own behalf, or on behalf of other systems coupled to the host. For example, a host may be a supercomputer processing large databases, a transaction processing server maintaining transaction records, and the like. Alternatively, the host may be a file server on a local area network (LAN) or wide area network (WAN) that provides storage services for an enterprise.

In a direct-attached storage solution, such a host may include one or more disk controllers or RAID controllers configured to manage multiple directly attached disk drives. By contrast, in a SAN a host connects to the SAN via a high-speed connection technology such as, e.g., a fibre channel (FC) fabric in the particular examples.

A virtualized SAN architecture comprises a group of storage cells, also referred to as storage arrays, where each storage cell comprises a pool of storage devices. Each storage cell comprises parallel storage array controllers coupled to storage devices using a fibre channel arbitrated loop connection, or through a network such as a fibre channel fabric or the like. The storage controllers may also be coupled to each other through point-to-point connections to enable them to cooperatively manage the presentation of storage capacity to computers using the storage capacity.

The network architectures described herein represent a distributed computing environment such as an enterprise computing system using a private SAN. However, the network architectures may be readily scaled upwardly or downwardly to meet the needs of a particular application.

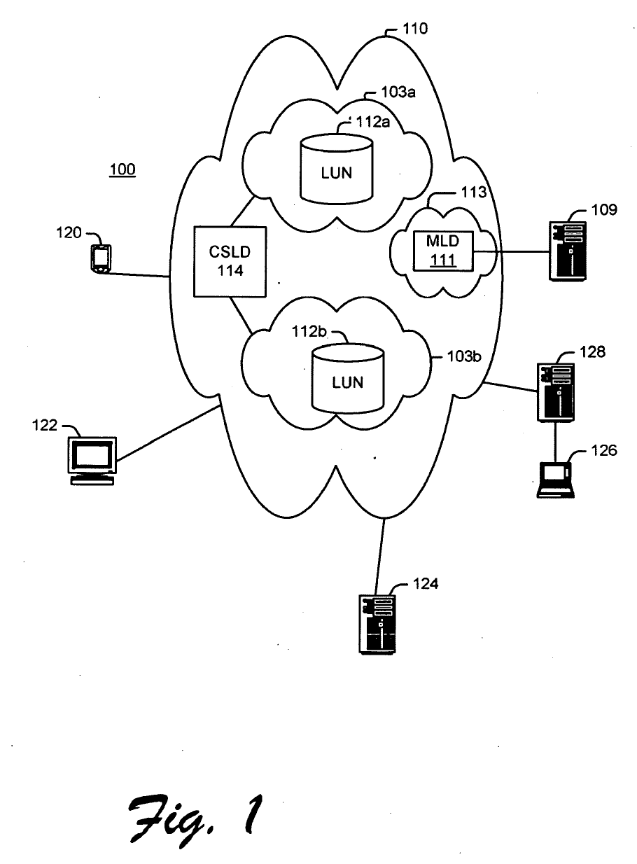

FIG. 1 is a schematic illustration of an exemplary implementation of a networked computing system 100 that utilizes a storage network. In one exemplary implementation, the storage pool 110 may be implemented as a virtualized storage pool as described in published U.S. Patent Application Publication No. 2003/0079102 to Lubbers, et al., the disclosure of which is incorporated herein by reference in its entirety.

A plurality of logical disks (also called logical units or LUNs) 112a, 112b may be allocated within storage pool 110. Each LUN 112a, 112b comprises a range of logical addresses that can be addressed by host devices 120, 122, 124 and 128 by mapping requests from the connection protocol used by the host device to the uniquely identified LUN 112a, 112b. A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which also may serve as hosts, may logically couple directly to LUNs 112a, 112b. Hosts 120-128 may couple to multiple LUNs 112a, 112b, and LUNs 112a, 112b may be shared among multiple hosts. Each of the devices shown in FIG. 1 may include memory, mass storage, and a degree of data processing capability sufficient to manage a network connection.

A LUN such as LUN 112a, 112b comprises one or more redundant stores (RStore) which are a fundamental unit of reliable storage. An RStore comprises an ordered set of physical storage segments (PSEGs) with associated redundancy properties and is contained entirely within a single redundant store set (RSS). By analogy to conventional storage systems, PSEGs are analogous to disk drives and each RSS is analogous to a RAID storage set comprising a plurality of drives.

The PSEGs that implements a particular LUN may be spread across any number of physical storage disks. Moreover, the physical storage capacity that a particular LUN 112 represents may be configured to implement a variety of storage types offering varying capacity, reliability and availability features. For example, some LUNs may represent striped, mirrored and/or parity-protected storage. Other LUNs may represent storage capacity that is configured without striping, redundancy or parity protection.

In an exemplary implementation an RSS comprises a subset of physical disks in a Logical Device Allocation Domain (LDAD), and may include from six to eleven physical drives (which can change dynamically). The physical drives may be of disparate capacities. Physical drives within an RSS may be assigned indices (e.g., 0, 1, 2, . . . , 11) for mapping purposes, and may be organized as pairs (i.e., adjacent odd and even indices) for RAID-1 purposes. One problem with large RAID volumes comprising many disks is that the odds of a disk failure increase significantly as more drives are added. A sixteen drive system, for example, will be twice as likely to experience a drive failure (or more critically two simultaneous drive failures), than would an eight drive system. Because data protection is spread within an RSS in accordance with the present invention, and not across multiple RSSs, a disk failure in one RSS has no effect on the availability of any other RSS. Hence, an RSS that implements data protection must suffer two drive failures within the RSS rather than two failures in the entire system. Because of the pairing in RAID-1 implementations, not only must two drives fail within a particular RSS, but a particular one of the drives within the RSS must be the second to fail (i.e. the second-to-fail drive must be paired with the first-to-fail drive). This atomization of storage sets into multiple RSSs where each RSS can be managed independently improves the performance, reliability, and availability of data throughout the system.

A SAN manager appliance 109 is coupled to a management logical disk set (MLD) 111 which is a metadata container describing the logical structures used to create LUNs 112a, 112b, LDADs 103a, 103b, and other logical structures used by the system. A portion of the physical storage capacity available in storage pool 110 is reserved as quorum space 113 and cannot be allocated to LDADs 103a, 103b, and hence cannot be used to implement LUNs 112a, 112b. In a particular example, each physical disk that participates in storage pool 110 has a reserved amount of capacity (e.g., the first “n” physical sectors) that may be designated as quorum space 113. MLD 111 is mirrored in this quorum space of multiple physical drives and so can be accessed even if a drive fails. In a particular example, at least one physical drive is associated with each LDAD 103a, 103b includes a copy of MLD 111 (designated a “quorum drive”). SAN management appliance 109 may wish to associate information such as name strings for LDADs 103a, 103b and LUNs 112a, 112b, and timestamps for object birthdates. To facilitate this behavior, the management agent uses MLD 111 to store this information as metadata. MLD 111 is created implicitly upon creation of each LDAD 103a, 103b.

Quorum space 113 is used to store information including physical store ID (a unique ID for each physical drive), version control information, type (quorum/non-quorum), RSS ID (identifies to which RSS this disk belongs), RSS Offset (identifies this disk's relative position in the RSS), Storage Cell ID (identifies to which storage cell this disk belongs), PSEG size, as well as state information indicating whether the disk is a quorum disk, for example. Quorum space implements a state database holding various metadata items including metadata describing the logical structure of a given LDAD 103 and metadata that is regularly used for tasks such as disk creation, leveling, RSS merging, RSS splitting, and regeneration. This metadata includes state information for each physical disk that indicates whether the physical disk is “Normal” (i.e., operating as expected), “Missing” (i.e., unavailable), “Merging” (i.e., a missing drive that has reappeared and must be normalized before use), “Replace” (i.e., the drive is marked for removal and data must be copied to a distributed spare), and “Regen” (i.e., the drive is unavailable and requires regeneration of its data to a distributed spare).

CSLD 114 is another type of metadata container comprising logical drives that are allocated out of address space within each LDAD 103a, 103b, but that, unlike LUNs 112a, 112b, may span multiple LDADs 103a, 103b. Preferably, each LDAD 103a, 103b includes space allocated to CSLD 114. A primary logical disk metadata container (PLDMC) contains an array of descriptors (called RSDMs) that describe every RStore used by each LUN 112a, 112b implemented within the LDAD 103a, 103b.

A logical disk directory (LDDIR) data structure is a directory of all LUNs 112a, 112b in any LDAD 103a, 103b. An entry in the LDDIR comprises a universally unique ID (UUID) and RSD indicating the location of a Primary Logical Disk Metadata Container (PLDMC) for that LUN 112. The RSD is a pointer to the base RSDM or entry point for the PLDMC corresponding to LUN 112a, 112b. In this manner, metadata specific to a particular LUN 112a, 112b can be accessed by indexing into the LDDIR to find the base RSDM of the particular PLDMC for LUN 112a, 112b. The metadata within the PLDMC (e.g., mapping structures described hereinbelow) can be loaded into memory to realize the particular LUN 112a, 112b.

Hence, the storage pool depicted in FIG. 1 implements multiple forms of metadata that can be used for recovery. Quorum space 113 implements metadata that is regularly used for tasks such as disk creation, leveling, RSS merging, RSS splitting, and regeneration

Each of the devices shown in FIG. 1 may include memory, mass storage, and a degree of data processing capability sufficient to manage a network connection. The computer program devices in accordance with the present invention are implemented in the memory of the various devices shown in FIG. 1 and enabled by the data processing capability of the devices shown in FIG. 1.

In an exemplary implementation an individual LDAD 103a, 103b may correspond to from as few as four disk drives to as many as several thousand disk drives. In particular examples, a minimum of eight drives per LDAD is required to support RAID-1 within the LDAD 103a, 103b using four pairs of disks. LUNs 112a, 112b defined within an LDAD 103a, 103b may represent a few megabytes of storage or less, up to 2 TByte of storage or more. Hence, hundreds or thousands of LUNs 112a, 112b may be defined within a given LDAD 103a, 103b, and thus serve a large number of storage needs. In this manner a large enterprise can be served by a single storage pool 110 providing both individual storage dedicated to each workstation in the enterprise as well as shared storage across the enterprise. Further, an enterprise may implement multiple LDADs 103a, 103b and/or multiple storage pools 110 to provide a virtually limitless storage capability. Logically, therefore, the virtual storage system in accordance with the present description offers great flexibility in configuration and access.

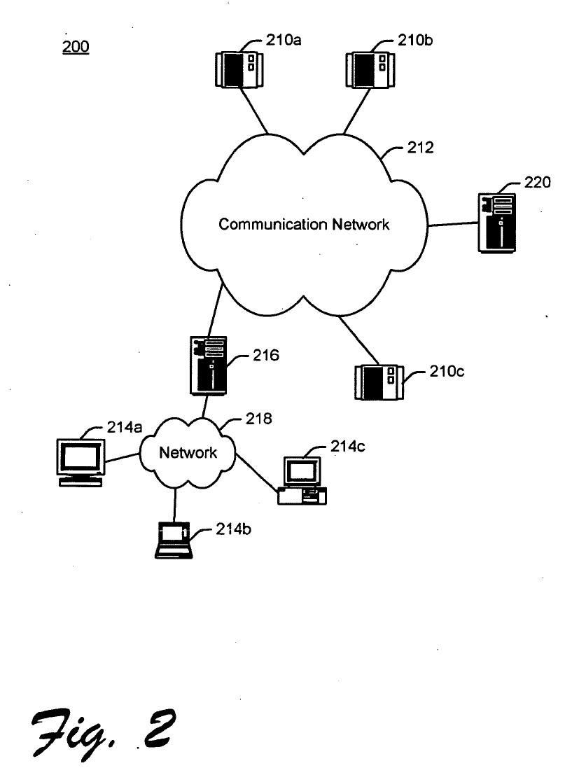

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available form Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (iSCSI) protocol.

Client computers 214a, 214b, 214c may access storage cells 210a, 210b, 210c through a host, such as servers 216, 220. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. By way of example, a switching fabric comprising a single FC switch can interconnect 256 or more ports, providing a possibility of hundreds of storage cells 210a, 210b, 210c in a single storage network.

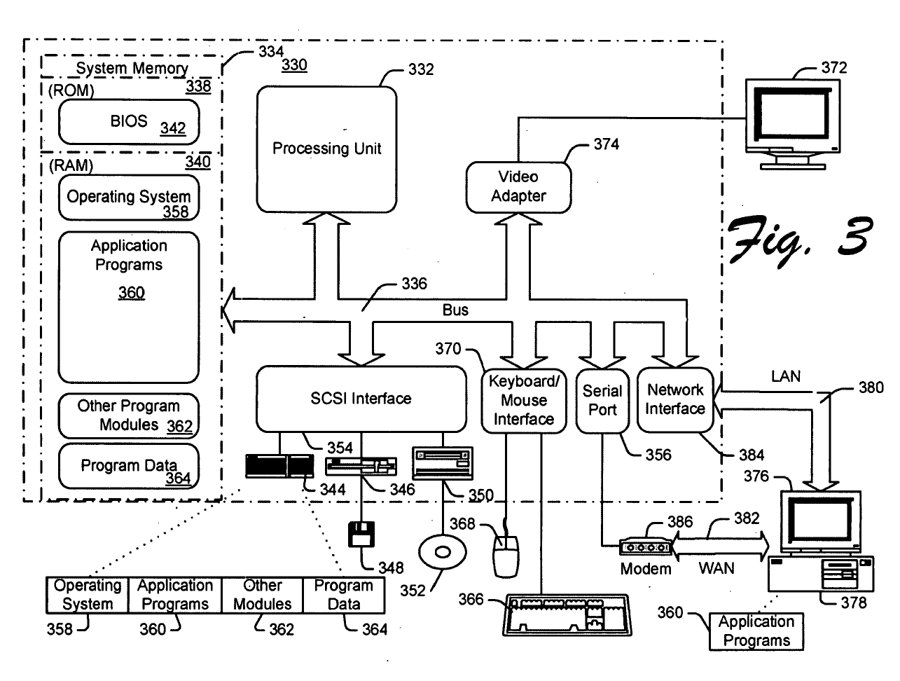

Hosts 216, 220 may be implemented as server computers. FIG. 3 is a schematic illustration of an exemplary computing device 330 that can be utilized to implement a host. Computing device 330 includes one or more processors or processing units 332, a system memory 334, and a bus 336 that couples various system components including the system memory 334 to processors 332. The bus 336 represents one or more of any of several types of bus structures, including a memory bus or memory controller, a peripheral bus, an accelerated graphics port, and a processor or local bus using any of a variety of bus architectures. The system memory 334 includes read only memory (ROM) 338 and random access memory (RAM) 340. A basic input/output system (BIOS) 342, containing the basic routines that help to transfer information between elements within computing device 330, such as during start-up, is stored in ROM 338.

Computing device 330 further includes a hard disk drive 344 for reading from and writing to a hard disk (not shown), and may include a magnetic disk drive 346 for reading from and writing to a removable magnetic disk 348, and an optical disk drive 350 for reading from or writing to a removable optical disk 352 such as a CD ROM or other optical media. The hard disk drive 344, magnetic disk drive 346, and optical disk drive 350 are connected to the bus 336 by a SCSI interface 354 or some other appropriate interface. The drives and their associated computer-readable media provide nonvolatile storage of computer-readable instructions, data structures, program modules and other data for computing device 330. Although the exemplary environment described herein employs a hard disk, a removable magnetic disk 348 and a removable optical disk 352, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 344, magnetic disk 348, optical disk 352, ROM 338, or RAM 340, including an operating system 358, one or more application programs 360, other program modules 362, and program data 364. A user may enter commands and information into computing device 330 through input devices such as a keyboard 366 and a pointing device 368. Other input devices (not shown) may include a microphone, joystick, game pad, satellite dish, scanner, or the like. These and other input devices are connected to the processing unit 332 through an interface 370 that is coupled to the bus 336. A monitor 372 or other type of display device is also connected to the bus 336 via an interface, such as a video adapter 374.

Computing device 330 may operate in a networked environment using logical connections to one or more remote computers, such as a remote computer 376. The remote computer 376 may be a personal computer, a server, a router, a network PC, a peer device or other common network node, and typically includes many or all of the elements described above relative to computing device 330, although only a memory storage device 378 has been illustrated in FIG. 3. The logical connections depicted in FIG. 3 include a LAN 380 and a WAN 382.

When used in a LAN networking environment, computing device 330 is connected to the local network 380 through a network interface or adapter 384. When used in a WAN networking environment, computing device 330 typically includes a modem 386 or other means for establishing communications over the wide area network 382, such as the Internet. The modem 386, which may be internal or external, is connected to the bus 336 via a serial port interface 356. In a networked environment, program modules depicted relative to the computing device 330, or portions thereof, may be stored in the remote memory storage device. It will be appreciated that the network connections shown are exemplary and other means of establishing a communications link between the computers may be used.

Referring briefly to FIG. 2, hosts 216, 220 may include host adapter hardware and software to enable a connection to communication network 212. The connection to communication network 212 may be through an optical coupling or more conventional conductive cabling depending on the bandwidth requirements. A host adapter may be implemented as a plug-in card on computing device 330. Hosts 216, 220 may implement any number of host adapters to provide as many connections to communication network 212 as the hardware and software support.

Generally, the data processors of computing device 330 are programmed by means of instructions stored at different times in the various computer-readable storage media of the computer. Programs and operating systems may distributed, for example, on floppy disks, CD-ROMs, or electronically, and are installed or loaded into the secondary memory of a computer. At execution, the programs are loaded at least partially into the computer's primary electronic memory.

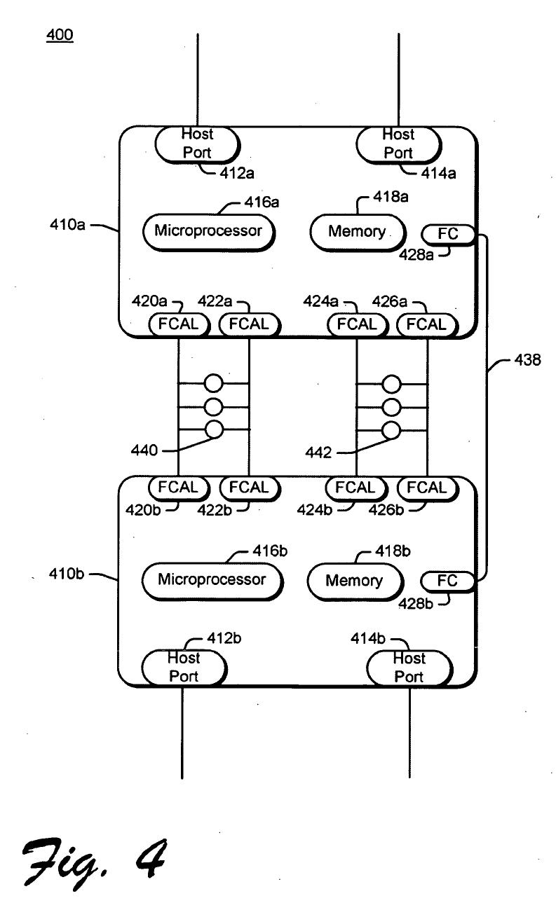

FIG. 4 is a schematic illustration of an exemplary implementation of a storage cell 400 that may be used to implement a storage cell such as 210a, 210b, or 210c. Referring to FIG. 4, storage cell 400 includes two Network Storage Controllers (NSCs), also referred to as storage array controllers, 410a, 410b to manage the operations and the transfer of data to and from one or more disk drives 440, 442. NSCs 410a, 410b may be implemented as plug-in cards having a microprocessor 416a, 416b, and memory 418a, 418b. Each NSC 410a, 410b includes dual host adapter ports 412a, 414a, 412b, 414b that provide an interface to a host, i.e., through a communication network such as a switching fabric. In a Fibre Channel implementation, host adapter ports 412a, 412b, 414a, 414b may be implemented as FC N_Ports. Each host adapter port 412a, 412b, 414a, 414b manages the login and interface with a switching fabric, and is assigned a fabric-unique port ID in the login process. The architecture illustrated in FIG. 4 provides a fully-redundant storage cell; only a single NSC is required to implement a storage cell.

Each NSC 410a, 410b further includes a communication port 428a, 428b that enables a communication connection 438 between the NSCs 410a, 410b. The communication connection 438 may be implemented as a FC point-to-point connection, or pursuant to any other suitable communication protocol.

In an exemplary implementation, NSCs 410a, 410b further include a plurality of Fiber Channel Arbitrated Loop (FCAL) ports 420a-426a, 420b-426b that implement an FCAL communication connection with a plurality of storage devices, e.g., arrays of disk drives 440, 442. While the illustrated embodiment implement FCAL connections with the arrays of disk drives 440, 442, it will be understood that the communication connection with arrays of disk drives 440, 442 may be implemented using other communication protocols. For example, rather than an FCAL configuration, a FC switching fabric or a small computer serial interface (SCSI) connection may be used.

In operation, the storage capacity provided by the arrays of disk drives 440, 442 may be added to the storage pool 110. When an application requires storage capacity, logic instructions on a host computer 128 establish a LUN from storage capacity available on the arrays of disk drives 440, 442 available in one or more storage sites. Data for the application is stored on one or more LUNs in the storage network. An application that needs to access the data queries a host computer, which retrieves the data from the LUN and forwards the data to the application.

One or more of the storage cells 210a, 210b, 210c in the storage network 200 may implement RAID-based storage. RAID (Redundant Array of Independent Disks) storage systems are disk array systems in which part of the physical storage capacity is used to store redundant data. RAID systems are typically characterized as one of six architectures, enumerated under the acronym RAID. A RAID 0 architecture is a disk array system that is configured without any redundancy. Since this architecture is really not a redundant architecture, RAID 0 is often omitted from a discussion of RAID systems.

A RAID 1 architecture involves storage disks configured according to mirror redundancy. Original data is stored on one set of disks and a duplicate copy of the data is kept on separate disks. The RAID 2 through RAID 5 architectures all involve parity-type redundant storage. Of particular interest, a RAID 5 system distributes data and parity information across a plurality of the disks. Typically, the disks are divided into equally sized address areas referred to as “blocks”. A set of blocks from each disk that have the same unit address ranges are referred to as “stripes”. In RAID 5, each stripe has N blocks of data and one parity block, which contains redundant information for the data in the N blocks.

In RAID 5, the parity block is cycled across different disks from stripe-to-stripe. For example, in a RAID 5 system having five disks, the parity block for the first stripe might be on the fifth disk; the parity block for the second stripe might be on the fourth disk; the parity block for the third stripe might be on the third disk; and so on. The parity block for succeeding stripes typically “precesses” around the disk drives in a helical pattern (although other patterns are possible). RAID 2 through RAID 4 architectures differ from RAID 5 in how they compute and place the parity block on the disks. The particular RAID class implemented is not important.

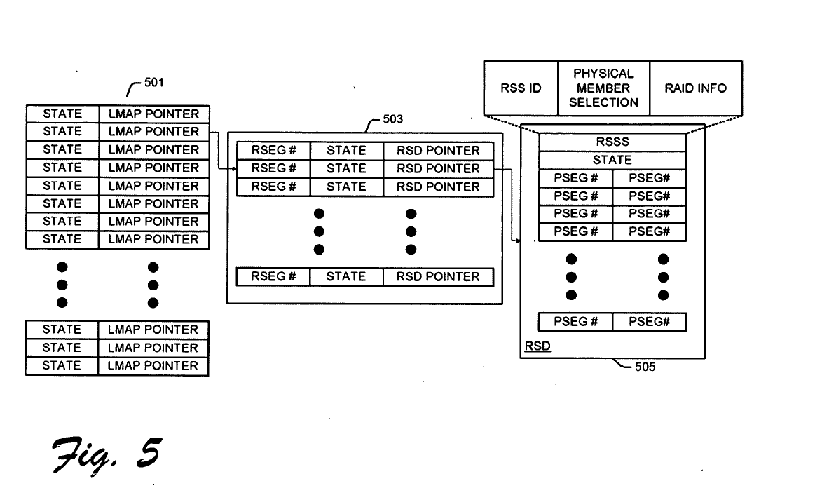

FIG. 5 illustrates a memory representation of a LUN 112a, 112b in one exemplary implementation. A memory representation is essentially a mapping structure that is implemented in memory of a NSC 410a, 410b that enables translation of a request expressed in terms of a logical block address (LBA) from host such as host 128 depicted in FIG. 1 into a read/write command addressed to a particular portion of a physical disk drive such as disk drive 440, 442. A memory representation desirably is small enough to fit into a reasonable amount of memory so that it can be readily accessed in operation with minimal or no requirement to page the memory representation into and out of the NSC's memory.

The memory representation described herein enables each LUN 112a, 112b to implement from 1 mbyte to 2 TByte in storage capacity. Larger storage capacities per LUN 112a, 112b are contemplated. For purposes of illustration a 2 Terabyte maximum is used in this description. Further, the memory representation enables each LUN 112a, 112b to be defined with any type of RAID data protection, including multi-level RAID protection, as well as supporting no redundancy at all. Moreover, multiple types of RAID data protection may be implemented within a single LUN 112a, 112b such that a first range of logical disk addresses (LDAS) correspond to unprotected data, and a second set of LDAs within the same LUN 112a, 112b implement RAID 5 protection. Hence, the data structures implementing the memory representation must be flexible to handle this variety, yet efficient such that LUNs 112a, 112b do not require excessive data structures.

A persistent copy of the memory representation shown in FIG. 5 is maintained in the PLDMDC for each LUN 112a, 112b described hereinbefore. The memory representation of a particular LUN 112a, 112b is realized when the system reads metadata contained in the quorum space 113 to obtain a pointer to the corresponding PLDMDC, then retrieves the PLDMDC and loads an level 2 map (L2MAP) 501. This is performed for every LUN 112a, 112b, although in ordinary operation this would occur once when a LUN 112a, 112b was created, after which the memory representation will live in memory as it is used.

A logical disk mapping layer maps a LDA specified in a request to a specific RStore as well as an offset within the RStore. Referring to the embodiment shown in FIG. 5, a LUN may be implemented using an L2MAP 501, an LMAP 503, and a redundancy set descriptor (RSD) 505 as the primary structures for mapping a logical disk address to physical storage location(s) represented by an address. The mapping structures shown in FIG. 5 are implemented for each LUN 112a, 112b. A single L2MAP handles the entire LUN 112a, 112b. Each LUN 112a, 112b is represented by multiple LMAPs 503 where the particular number of LMAPs 503 depend on the actual address space that is allocated at any given time. RSDs 505 also exist only for allocated storage space. Using this split directory approach, a large storage volume that is sparsely populated with allocated storage, the structure shown in FIG. 5 efficiently represents the allocated storage while minimizing data structures for unallocated storage.

L2MAP 501 includes a plurality of entries where each entry represents 2 Gbyte of address space. For a 2 Tbyte LUN 112a, 112b, therefore, L2MAP 501 includes 1024 entries to cover the entire address space in the particular example. Each entry may include state information corresponding to the corresponding 2 Gbyte of storage, and a pointer a corresponding LMAP descriptor 503. The state information and pointer are only valid when the corresponding 2 Gbyte of address space have been allocated, hence, some entries in L2MAP 501 will be empty or invalid in many applications.

The address range represented by each entry in LMAP 503, is referred to as the logical disk address allocation unit (LDAAU). In the particular implementation, the LDAAU is 1 MByte. An entry is created in LMAP 503 for each allocated LDAAU irrespective of the actual utilization of storage within the LDMU. In other words, a LUN 112 can grow or shrink in size in increments of 1 Mbyte. The LDAAU is represents the granularity with which address space within a LUN 112a, 112b can be allocated to a particular storage task.

An LMAP 503 exists only for each 2 Gbyte increment of allocated address space. If less than 2 Gbyte of storage are used in a particular LUN 112a, 112b, only one LMAP 503 is required, whereas, if 2 Tbyte of storage is used, 1024 LMAPs 503 will exist. Each LMAP 503 includes a plurality of entries where each entry optionally corresponds to a redundancy segment (RSEG). An RSEG is an atomic logical unit that is roughly analogous to a PSEG in the physical domain—akin to a logical disk partition of an RStore. In a particular embodiment, an RSEG is a logical unit of storage that spans multiple PSEGs and implements a selected type of data protection. Entire RSEGs within an RStore are bound to contiguous LDAs in a preferred implementation. In order to preserve the underlying physical disk performance for sequential transfers, it is desirable to adjacently locate all RSEGs from an RStore in order, in terms of LDA space, so as to maintain physical contiguity. If, however, physical resources become scarce, it may be necessary to spread RSEGs from RStores across disjoint areas of a LUN 112. The logical disk address specified in a request 501 selects a particular entry within LMAP 503 corresponding to a particular RSEG that in turn corresponds to 1 Mbyte address space allocated to the particular RSEG#. Each LMAP entry also includes state information about the particular RSEG, and an RSD pointer.

Optionally, the RSEG#s may be omitted, which results in the RStore itself being the smallest atomic logical unit that can be allocated. Omission of the RSEG# decreases the size of the LMAP entries and allows the memory representation of a LUN 112 to demand fewer memory resources per MByte of storage. Alternatively, the RSEG size can be increased, rather than omitting the concept of RSEGs altogether, which also decreases demand for memory resources at the expense of decreased granularity of the atomic logical unit of storage. The RSEG size in proportion to the RStore can, therefore, be changed to meet the needs of a particular application.

The RSD pointer points to a specific RSD 505 that contains metadata describing the RStore in which the corresponding RSEG exists. As shown in FIG. 5, the RSD includes a redundancy storage set selector (RSSS) that includes a redundancy storage set (RSS) identification, a physical member selection, and RAID information. The physical member selection is essentially a list of the physical drives used by the RStore. The RAID information, or more generically data protection information, describes the type of data protection, if any, that is implemented in the particular RStore. Each RSD also includes a number of fields that identify particular PSEG numbers within the drives of the physical member selection that physically implement the corresponding storage capacity. Each listed PSEG# corresponds to one of the listed members in the physical member selection list of the RSSS. Any number of PSEGs may be included, however, in a particular embodiment each RSEG is implemented with between four and eight PSEGs, dictated by the RAID type implemented by the RStore.

In operation, each request for storage access specifies a LUN 112a, 112b, and an address. A NSC such as NSC 410a, 410b maps the logical drive specified to a particular LUN 112a, 112b, then loads the L2MAP 501 for that LUN 112 into memory if it is not already present in memory. Preferably, all of the LMAPs and RSDs for the LUN 112 are loaded into memory as well. The LDA specified by the request is used to index into L2MAP 501, which in turn points to a specific one of the LMAPS. The address specified in the request is used to determine an offset into the specified LMAP such that a specific RSEG that corresponds to the request-specified address is returned. Once the RSEG# is known, the corresponding RSD is examined to identify specific PSEGs that are members of the redundancy segment, and metadata that enables a NSC 410a, 410b to generate drive specific commands to access the requested data. In this manner, an LDA is readily mapped to a set of PSEGs that must be accessed to implement a given storage request.

The L2MAP consumes 4 Kbytes per LUN 112a, 112b regardless of size in an exemplary implementation. In other words, the L2MAP includes entries covering the entire 2 Tbyte maximum address range even where only a fraction of that range is actually allocated to a LUN 112a, 112b. It is contemplated that variable size L2MAPs may be used, however such an implementation would add complexity with little savings in memory. LMAP segments consume 4 bytes per Mbyte of address space while RSDs consume 3 bytes per MB. Unlike the L2MAP, LMAP segments and RSDs exist only for allocated address space.

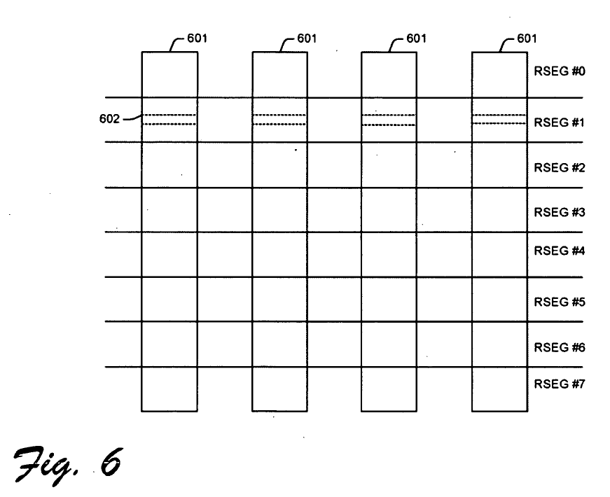

FIG. 6 is a schematic illustration of data allocation in a virtualized storage system. Referring to FIG. 6, a redundancy layer selects PSEGs 601 based on the desired protection and subject to NSC data organization rules, and assembles them to create Redundant Stores (RStores). The set of PSEGs that correspond to a particular redundant storage set are referred to as an “RStore”. Data protection rules may require that the PSEGs within an RStore are located on separate disk drives, or within separate enclosure, or at different geographic locations. Basic RAID-5 rules, for example, assume that striped data involve striping across independent drives. However, since each drive comprises multiple PSEGs, the redundancy layer of the present invention ensures that the PSEGs are selected from drives that satisfy desired data protection criteria, as well as data availability and performance criteria.

RStores are allocated in their entirety to a specific LUN 112. RStores may be partitioned into 1 Mbyte segments (RSEGs) as shown in FIG. 6. Each RSEG in FIG. 6 presents only 80% of the physical disk capacity consumed as a result of storing a chunk of parity data in accordance with RAID 5 rules. When configured as a RAID 5 storage set, each RStore will comprise data on four PSEGs, and parity information on a fifth PSEG (not shown) similar to RAID4 storage. The fifth PSEG does not contribute to the overall storage capacity of the RStore, which appears to have four PSEGs from a capacity standpoint. Across multiple RStores the parity will fall on various drives so that RAID 5 protection is provided.

RStores are essentially a fixed quantity (8 MByte in the examples) of virtual address space. RStores consume from four to eight PSEGs in their entirety depending on the data protection level. A striped RStore without redundancy consumes 4 PSEGs (4-2048 KByte PSEGs=8 MB), an RStore with 4+1 parity consumes 5 PSEGs and a mirrored RStore consumes eight PSEGs to implement the 8 Mbyte of virtual address space.

An RStore is analogous to a RAID disk set, differing in that it comprises PSEGs rather than physical disks. An RStore is smaller than conventional RAID storage volumes, and so a given LUN 112 will comprise multiple RStores as opposed to a single RAID storage volume in conventional systems.

It is contemplated that drives may be added and removed from an LDAD 103 over time. Adding drives means existing data can be spread out over more drives while removing drives means that existing data must be migrated from the exiting drive to fill capacity on the remaining drives. This migration of data is referred to generally as “leveling”. Leveling attempts to spread data for a given LUN 112 over as many physical drives as possible. The basic purpose of leveling is to distribute the physical allocation of storage represented by each LUN 112 such that the usage for a given logical disk on a given physical disk is proportional to the contribution of that physical volume to the total amount of physical storage available for allocation to a given logical disk.

Existing RStores can be modified to use the new PSEGs by copying data from one PSEG to another and then changing the data in the appropriate RSD to indicate the new membership. Subsequent RStores that are created in the RSS will use the new members automatically. Similarly, PSEGs can be removed by copying data from populated PSEGs to empty PSEGs and changing the data in LMAP 502 to reflect the new PSEG constituents of the RSD. In this manner, the relationship between physical storage and logical presentation of the storage can be continuously managed and updated to reflect current storage environment in a manner that is invisible to users.

In one aspect, one or more of the storage controllers in a storage system may be configured to copy logical disk mappings between storage array controllers, e.g., from a source storage controller to a destination storage controller. In some embodiments, the copy process may be implemented as part of a process to transfer a logical group from the source controller to the destination controller.

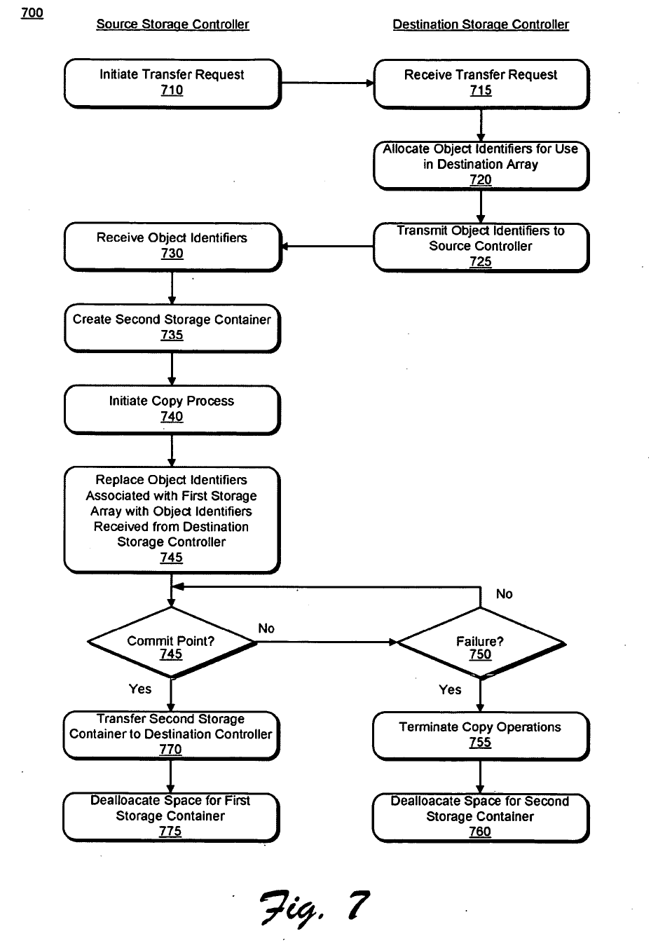

FIG. 7 is a flowchart illustrating operations in a method to copy logical disk mappings between storage arrays. In some embodiments, the operations depicted in FIG. 7 may be implemented when a disk group is transferred between controllers in different storage cells. As mentioned above, the operations depicted in FIG. 7 may be stored in a computer readable storage medium, e.g., in a memory module 418a, 418b on a storage array controller 410a, 410b, and implemented by a processor 416a, 416b on the array controller.

Referring to FIG. 7, at operation 710 a source storage controller initiates a transfer request to transfer access of a disk group to a destination controller. One skilled in the art will recognize that the designation of source controller and destination controller is essentially arbitrary. In practice, a given storage array controller may serve as a source controller or a destination controller, or as a source controller for a first disk group and a destination controller for a second disk group.

The transfer request is transmitted to the destination storage controller. At operation 715 the destination storage controller receives the transfer request, and at operation 720 the destination storage controller allocates object identifiers for use with the disk group in the destination array managed by the destination storage controller. In some embodiments, the source storage controller transmits with the transfer request an indication of the numbers of objects of various types required by the disk group being transferred to the destination storage controller. The destination storage controller may use this information to allocate object identifiers for use in the destination array with the transferred disk group. For example, the object identifiers may be used as identifiers in a namespace to objects managed by the destination storage controller. At operation 725 the object identifiers are transmitted from the destination storage controller to the source storage controller.

At operation 730 the source storage controller receives the object identifiers from the destination storage controller. At operation 735 the source storage controller begins the process of copying the logical disk mapping by creating a storage container. In some embodiments, a new PLDMC is created for each LUN in the disk group. As described above, in some embodiments the logical disk mapping may be contained in a storage container referred to as a primary logical disk metadata container (PLDMC). As used herein, the PLDMC maintained by the source storage controller is considered the first storage container. Hence, in operation 735 the new storage container created by the source storage controller is referred to as the second storage container.

At operation 740 the source storage controller initiates a copy process to copy the contents of the PLDMC maintained by the source storage controller to the second storage container. During the copy process, at operation 745, the object identifiers associated with the first storage array are replaced with the object identifiers received from the destination storage controller.

During the copy process, input/output operations directed to the disk group are handled by the source storage controller. Input/output operations which change the data in the PLDMC are mirrored into the copy of the PLDMC maintained in the second storage container. In some implementations, the copy process includes a commit point, prior to which failures will result in termination of the process. Thus, if at operation 745 the commit point in the process is not reached, then control passes to operation 750. If, at operation 750 there is not a failure, then the copy process continues. By contrast, if at operation 750 a failure occurs before the copy process reaches a commit point, then control passes to operation 755 and the copy process is terminated. At operation 760 the space allocated for the second storage container is deallocated. Operations may then continue with the source storage controller continuing to manage access to the disk group. Optionally, the source storage controller may generate an error message indicating that the transfer operation was halted due to a failure event.

By contrast, if at operation 745 the copy process has reached a commit point, then control passes to operation 770 and the second storage container is transferred to the destination controller. At operation 775 the source storage controller deallocates the space allocated for the first storage container (i.e., the PLDMC) for the disk group in the source storage controller. Subsequently, access to the disk group may be transferred to the destination storage controller, and input/output operations directed to the disk group can be directed to the destination storage controller using the second storage container.

Thus, the operations depicted in FIG. 7 enable a source storage controller to generate a copy of logical disk mappings used with a disk group, but which maps appropriately to objects associated with a destination storage controller. In addition, the use of a commit point in the copy process makes the copy process atomic in the sense that either all the object identifiers are changed in the logical disk mappings or none of them are.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A storage controller, comprising:
a first port that provides an interface to a host computer;
a second port that provides an interface to a storage device;
a processor; and
a memory module communicatively connected to the processor and comprising logic instructions stored on a computer readable storage medium which, when executed by the processor, configure the processor to copy a logical disk mapping from a first storage array managed by a source storage controller to a second storage array managed by a destination storage controller by performing operations comprising:
obtaining, in the source storage controller, an object identifier listing for use with the logical disk mappings in the destination storage controller;
copying, in the source storage controller, contents of logical disk mappings for use in the first storage array from a first storage container to a second storage container; and
replacing, in the source storage controller, object identifiers associated with the logical disk mappings in the first storage array with object identifiers from the object identifier listing received in the first storage controller.

2. The storage controller of claim 1, wherein obtaining, in the source storage controller, an object identifier listing for use with the logical disk mappings in the destination storage controller comprises:
initiating, in the source storage controller, a request to transfer control of a logical disk mapping to the destination storage controller; and
receiving, in the source storage controller, an object identifier listing from the destination storage controller.

3. The storage controller of claim 2, wherein copying, in the source storage controller, contents of logical disk mappings for use in the first storage array from a first storage container to a second storage container comprises generating a mirror copy of the logical disk mappings in the source controller.

4. The storage controller of claim 1, further comprising servicing input/output requests in the source controller using the logical disk mappings in the first storage container while the logical disk mappings are copied to the second storage container.

5. The storage controller of claim 4 further comprising:
receiving, in the source storage controller, an input/output operation which implements a change to a logical mapping in first storage container; and
mirroring the change to the logical mapping in the second storage container.

6. The storage controller of claim 1, wherein:
the source storage controller defines a commit point in the copy process; and
in response to failure events which occur prior to the commit point, the source storage controller terminates the copying the logical mapping and deallocates the storage space for the second storage container.

7. The storage controller of claim 6, wherein after the commit point is reached:
the source storage controller transfers the second container to the destination controller; and
the source storage controller deallocates the storage space allocated to the first storage container.

8. A computer program product comprising logic instructions stored in a computer readable medium which, when executed by a processor, configure the processor to copy a logical disk mapping between from a first storage array managed by a source storage controller to a second storage array managed by a destination storage controller by performing operations comprising:
obtaining, in the source storage controller, an object identifier listing for use with the logical disk mappings in the destination storage controller;
copying, in the source storage controller, contents of logical disk mappings for use in the first storage array from a first storage container to a second storage container; and
replacing, in the source storage controller, object identifiers associated with the logical disk mappings in the first storage array with object identifiers from the object identifier listing received in the first storage controller.

9. The computer program product of claim 8, wherein obtaining, in the source storage controller, an object identifier listing for use with the logical disk mappings in the destination storage controller comprises:
initiating, in the source storage controller, a request to transfer control of a logical disk mapping to the destination storage controller; and
receiving, in the source storage controller, an object identifier listing from the destination storage controller.

10. The computer program product of claim 9, wherein copying, in the source storage controller, contents of logical disk mappings for use in the first storage array from a first storage container to a second storage container comprises generating a mirror copy of the logical disk mappings in the source controller.

11. The computer program product of claim 8, further comprising servicing input/output requests in the source controller using the logical disk mappings in the first storage container while the logical disk mappings are copied to the second storage container.

12. The computer program product of claim 11 further comprising:
receiving, in the source storage controller, an input/output operation which implements a change to a logical mapping in first storage container; and
mirroring the change to the logical mapping in the second storage container.

13. The computer program product of claim 8, wherein:
the source storage controller defines a commit point in the copy process; and
in response to failure events which occur prior to the commit point, the source storage controller terminates the copying the logical mapping and deallocates the storage space for the second storage container.

14. A method to copy a logical disk mapping from a first storage array managed by a source storage controller to a second storage array managed by a destination storage controller, comprising:
obtaining, in the source storage controller, an object identifier listing for use with the logical disk mappings in the destination storage controller;
copying, in the source storage controller, contents of logical disk mappings for use in the first storage array from a first storage container to a second storage container; and
replacing, in the source storage controller, object identifiers associated with the logical disk mappings in the first storage array with object identifiers from the object identifier listing received in the first storage controller.

15. The method of claim 1, wherein obtaining, in the source storage controller, an object identifier listing for use with the logical disk mappings in the destination storage controller comprises:
initiating, in the source storage controller, a request to transfer control of a logical disk mapping to the destination storage controller; and
receiving, in the source storage controller, an object identifier listing from the destination storage controller.
